(19) United States
(12) Patent Application Publication
(10) Pub. No.: US 2006/0190953 A1
(43) Pub. Date: Aug. 24, 2006

(54) Disk recording/reproducer and method for fixing pickup of disc recorder/reproducer

(75) Inventors: Hiroshi Nakashima, Osaka (JP); Yoshiaki Kanamori, Hyogo (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: SANYO ELECTRIC CO., LTD., Moriguchi-shi (JP)

(21) Appl. No.: 10/565,854

(22) PCT Filed: Jul. 20, 2004
(86) PCT No.: PCT/JP04/10292

§ 371 Date: Jan. 26, 2006

(30) Foreign Application Priority Data
Jul. 30, 2003 (JP) 2003-203473

(51) Int. Cl. G11B 7/08

(52) U.S. Cl. 720/676

(57) ABSTRACT

A disk recording or reproducing apparatus includes, on a chassis (1), a pickup (2), which is moved while emitting a laser beam onto a signal surface of a disk (7), and a pair of guide shafts (4) and (40) for guiding the movement of the pickup (2). One guide shaft (4) is fitted to the pickup (2) with a fewer play than the other guide shaft (40). Both ends of the guide shaft (4) fitted to the pickup (2) with a fewer play are supported by support members (5) and (50) mounted on the chassis (1), respectively, and further, a cutout (52), into which the guide shaft (4) can be inserted, is formed on a side of at least one support member (50). A pressing member (9) including an abutting piece (90) is provided for preventing the guide shaft (4) from slipping off from the cutout (52) in the vicinity of the support member (50) having the cutout (52) formed thereat on the chassis (1).

### TECHNICAL FIELD

The present invention relates to a disk recording or reproducing apparatus and a method of fixing a pickup to the apparatus.

### BACKGROUND ART

FIG. 4 is a plan view showing a conventional disk recording or reproducing apparatus. As well known, a turn table (3) for rotating a disk (7), and a pickup (2) disposed so as to be able to move close to or away from the turn table (3) are mounted on a chassis (1) made of a metallic plate. The pickup (2) moves along guide shafts (4) and (40) with the application of electric power from a pickup drive motor (M2) mounted on the chassis (1).

As shown in FIG. 5, the pickup (2) includes bearings (20) and (20), which are fitted to one guide shaft (4) with a small play, and a fitting piece (21), which is fitted to the other guide shaft (40) with a large play and has an opening (22) at a side surface. The pickup (2) moves by the guide of the guide shaft (4) with a small play. In the description below, the guide shaft (4) with a small play is referred to as a main shaft, and the guide shaft (40) with a large play is referred to as an auxiliary shaft.

When a signal is reproduced, a signal surface of the disk (7) is irradiated with a laser beam from a lens (24) of the pickup (2), and a reflected signal is read by the pickup (2) and reproduced.

FIG. 6 is a side view illustrating a focusing state of the lens (24). As a beam aperture φ of the lens (24) becomes smaller, a signal recording density becomes higher. Assuming that a recording/reproducing wavelength is designated by λ, the beam aperture φ is expressed by an equation φ=kλ/2 NA (where k denotes a proportional constant), as well known. Here, NA (Numerical Aperture) signifies the number of apertures, which is expressed by sin θ, wherein θ denotes an angle formed by a center line L of the lens (24) and the beam. Therefore, in order to increase the disk recording density, the wavelength λ is reduced, and further, the NA is increased. In recent years, there is developed a DVD (abbreviating a digital versatile disk) which can record and reproduce not only a voice signal but also a video signal. In the above-described DVD, the recording density need be increased. For this reason, while the lens (24) for a CD (Compact Disk) for reproducing a voice signal is an NA of 0.45, the lens (24) for use in the DVD is an NA of 0.6. As a consequence, since the lens for the DVD has a smaller beam aperture φ in comparison with the lens for the CD, there is the possibility that the beam cannot be focused at a regular position if the disk is inclined from the regular position and the signal cannot be accurately reproduced. In view of this, there is provided an adjusting mechanism for inclining the pickup (2) within a plane including the longitudinal direction of the guide shafts (4) and (40) and being substantially perpendicular to the surface of the chassis (1) (S1 in FIG. 4).

FIG. 7 is a cross-sectional view, as viewed in a direction indicated by an arrow A1 in FIG. 4; and FIG. 8 is a left cross-sectional view of FIG. 4. One end of each of the guide shafts (4) and (40) is fitted into a vertical hole (51) formed at each of support members (5) and (5a) formed by bending the chassis (1). The lower end of each of the guide shafts (4) and (40) is received by each of screws (47) screwed from under the chassis (1). The other end of each of the guide shafts (4) and (40) is fitted to each of brackets (85) having openings (86) oriented toward the support members (5) and (5a), respectively, to be then urged downward by a spring (87) inside of the bracket (85). The lower end of each of the guide shafts (4) and (40) is received by an adjusting screw (48) penetrating through the bracket (85) screwed from under the chassis (1). When the adjusting screw (48) is rotated, each of the guide shafts (4) and (40) is inclined toward a direction indicated by an arrow E in FIG. 7 on a point of each of the guide shafts (4) and (40) in abutment against the screw (47) as a furculum. That is to say, the guide shafts (4) and (40) need be disposed in an elevatable manner. In the actual adjustment of the inclination of each of the guide shafts (4) and (40), a manufacturer of the disk recording or reproducing apparatus rotates the adjusting screw (48) while reproducing the disk having a reference signal recorded thereon, and then, stops the rotation of the adjusting screw (48) at the time when a reproducing signal becomes most appropriate.

[Patent Literature 1] Japanese Patent Application Laid-open No. 2002-288948

### DISCLOSURE OF THE INVENTION

Problems to Be Solved by the Invention

FIG. 9 is a plan view simply illustrating a state in which the pickup (2) is fixed to the chassis (1). In fixing the pickup (2) to the chassis (1), the guide shaft (40) serving as the auxiliary shaft is first fitted to one of the brackets (85) and the support member (5a). Next, the fitting piece (21) of the pickup (2) is sideways fitted around the guide shaft (40), and further, the bearings (20) for the pickup (2) are interposed between the other bracket (85) and the support member (5). Thereafter, the guide shaft (4) serving as the main shaft is fitted outside of the support member (5), so that the guide shaft (4) penetrating through the vertical hole (51) of the support member (5) is inserted into the bearings (20). Finally, the guide shaft (4) inserted into the bearings (20) is further inserted into the opening (86) formed at the bracket (85).

However, since the guide shaft (40) serving as the auxiliary shaft has a large play with respect to the fitting piece (21), the pickup (2) is liable to be swung within a plane parallel to the chassis (1). Moreover, the guide shaft (40) is elevatably provided for adjusting the inclination, and therefore, the guide shaft (40) is fitted into the opening (86) formed at the bracket (85) and the vertical hole (51) formed at the support member (5a) with a play. Consequently, the pickup (2) fitted to the guide shaft (40) is liable to be swung further.

If the pickup (2) is accidentally swung, the guide shaft (4) inserted into the bearings (20) cannot be precisely inserted into the bracket (85), thereby raising a problem of poor workability. In addition, when the guide shaft (4) penetrating through the vertical hole (51) of the support member (5) is inserted into the bearings (20), the bearings (20) may be possibly damaged.

Therefore, an object of the present invention is to provide a disk recording or reproducing apparatus, in which a pickup (2) can be readily fixed to a chassis (1).

Means for Solving the Problems

Both ends of a guide shaft (4) fitted to a pickup (2) with a fewer play are supported by support members (5) and

(50) mounted on a chassis (1), and further, a cutout (52), into which the guide shaft (4) can be inserted, is formed on a side of at least one support member (50).

A pressing member (9) including an abutting piece (90) is provided for preventing the guide shaft (4) from slipping off from the cutout (52) in the vicinity of the support member (50) having the cutout (52) formed thereat on the chassis (1).

Moreover, the abutting piece (90) in the pressing member (9) is formed by bending a mount plate (93) mounted on the chassis (1), wherein the abutting piece (90) abuts against the guide shaft (4) at an end surface (90a) thereof.

Advantageous Results of the Invention

The pickup (2) is fixed to the chassis (1), as described below. The guide shaft (40) serving as the auxiliary shaft is fixed to the chassis (1) in advance. The pickup (2) is fixed to the guide shaft (40) with a play.

Next, the pickup (2) is swung within a plane parallel to the chassis (1) on a point in abutment against the guide shaft (40) as a furculum. The guide shaft (4) is fitted to the pickup (2). One end of the guide shaft (4) is fitted to one support member (5). The other end of the guide shaft (4) cannot abut against the other support member (50) since the pickup (2) is swung.

Subsequently, the guide shaft (4) is fitted to the other support member (50) through the cutout (52) formed on the side of the support member (50). Thereafter, the pressing member (9) is mounted on the chassis (1). The abutting piece (90) of the pressing member (9) can prevent the guide shaft (4) from slipping off from the cutout (52). The guide shaft (4) can be sideways fitted to the support member (50), thereby enhancing workability in fixing the guide shaft (4) to the chassis (1).

Additionally, the abutting piece (90) is formed by bending the mount plate (93), and further, the guide shaft (4) is pressed at the end surface (90a) of the abutting piece (90). The abutting piece (90) is made of a plate member, wherein flexure generated with the application of force to the plate member is inversely proportional to a secondary moment at a cross section of the plate member. The secondary moment at a cross section in the case where force is exerted at the end surface of the plate member becomes greater than that in the case where the force is exerted at the surface of the plate member, so that the plate member is hardly flexed. That is to say, even if a large swing force or a large impact is exerted on the guide shaft (4) within the plane parallel to the chassis (1), the abutting piece (90) is hardly flexed since the guide shaft (4) is pressed at the end surface (90a) of the abutting piece (90). Thus, it is possible to prevent any swing of the guide shaft (4).

### BRIEF DESCRIPTION OF THE DRAWINGS

FIG. 1 is a plan view showing a disk recording or reproducing apparatus.

FIG. 2 is a perspective view showing a pressing member and a second support member, as viewed in a direction indicated by an arrow F in FIG. 1.

FIG. 3 is a plan view illustrating procedures for fixing a pickup to a chassis.

FIG. 4 is a plan view showing a disk recording or reproducing apparatus in the conventional art.

FIG. 5 is a left side view showing a pickup.

FIG. 6 is a side view illustrating a focusing state of a lens.

FIG. 7 is a cross-sectional view, as viewed in a direction indicated by an arrow A1 in FIG. 4.

FIG. 8 is a left side view of FIG. 4.

FIG. 9 is a plan view simply illustrating a state in which the pickup is fixed to a chassis in the conventional

### DESCRIPTION OF THE REFERENCE NUMERALS

1 chassis
2 pickup
4 guide shaft
5 support member
9 pressing member

### BEST MODE CARRYING OUT THE INVENTION

A description will be given below of a preferred embodiment according to the present invention in reference to the attached drawings.

FIG. 1 is a plan view showing a disk recording or reproducing apparatus in a preferred embodiment. Like in the conventional art, a turn table (3) for rotating a disk and a pickup (2) disposed in such a manner as to be freely brought into or out of contact with the turn table (3) are mounted on a chassis (1) made of a metallic plate. The pickup (2) is moved along guide shafts (4) and (40) with the application of electric power from a pickup drive motor (M2) mounted on the chassis (1) via a screw shaft (17) and a rack piece (23). The rack piece (23) is located under the screw shaft (17), and further, is urged upward of the screw shaft (17) by a disk spring, not shown, disposed at the pickup (2). On the chassis (1) is formed a large opening (11), across which the guide shafts (4) and (40) are disposed. The pickup (2) is fitted inside of the large opening (11). Like the configuration in the conventional art, the pickup (2) includes bearings (20) and a fitting piece (21).

Respectively at four corners of the chassis (1), dampers (18) are disposed. In the vicinity of three of the dampers (18), (18), and (18) are provided first support members (5), (5a) and (5a), respectively, and further, in the vicinity of one damper (18a) are provided a pressing member (9) and a second support member (50). Like the configuration in the conventional art shown in FIG. 8, the first support members (5), (5a) and (5a) are formed by bending the chassis (1), and further, have vertical holes (51), respectively, into which the guide shafts (4) and (40) are inserted.

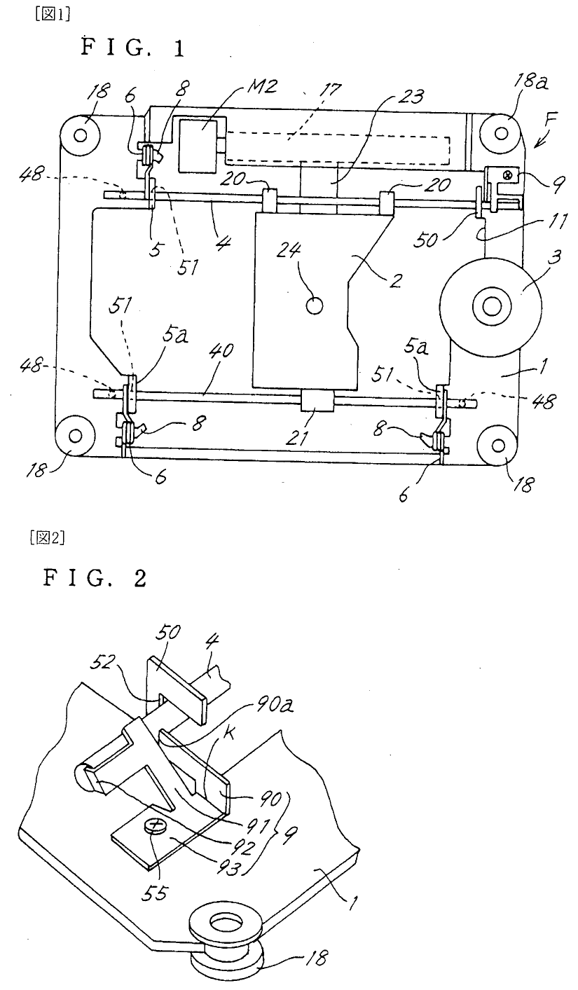

FIG. 2 is a perspective view showing the pressing member (9) and the second support member (50), as viewed in a direction indicated by an arrow F in FIG. 1. The second support member (50) is formed by bending the chassis (1), and further, has a cutout (52) on a side thereof. The guide shaft (4) is brought into contact with a side edge of the cutout (52).

The pressing member (9) is formed by bending a metallic plate, and further, includes, on a mount plate (93) in contact with the chassis (1), an abutting piece (90) for preventing the guide shaft (4) from slipping off from the cutout (52), a pressing piece (91) for urging the guide shaft (4) downward, and a stopper piece (92) in contact with the end surface of the guide shaft (4).

The pressing member (9) is fixed to the chassis (1) via a screw (55). A boundary line K between the abutting piece (90) and the mount plate (93) is substantially perpendicular to a longitudinal direction of the guide shaft (4), and further, an end surface (90a) of the abutting piece (90) abuts against the guide shaft (4). In other words, the guide shaft (4) is held between the end surface (90a) of the abutting piece (90) and a side edge of the cutout (52) formed at the second support member (50), to be thus restricted from being swung within a plane parallel to the chassis (1). Moreover, the guide shaft (4) can be restricted from being moved outward along the longitudinal direction by the stopper piece (92).

Inside of the large opening (11) shown in FIG. 1, a spring holding piece (8) is disposed outside of each of the first support members (5), (5a) and (5a). A winding portion of a torsion spring (6) is fitted to the spring holding piece (8). The guide shafts (4) and (40) are urged downward by one of leg pieces of the torsion spring (6). The other leg pieces of the torsion springs (6) are brought into contact with the chassis (1).

Adjusting screws (48) are screwed from under the chassis (1), and further, are brought, at tips thereof, into contact with lower ends of the guide shafts (4) and (40). When the adjusting screws (48) are rotated, the inclination of the guide shafts (4) and (40) can be adjusted against the torsion springs (6). The matter of the adjustment of the inclination is identical to that in the conventional art.

(Pickup Fixing Procedures)

Explanation will be made below on procedures for fixing the pickup (2) to the chassis (1).

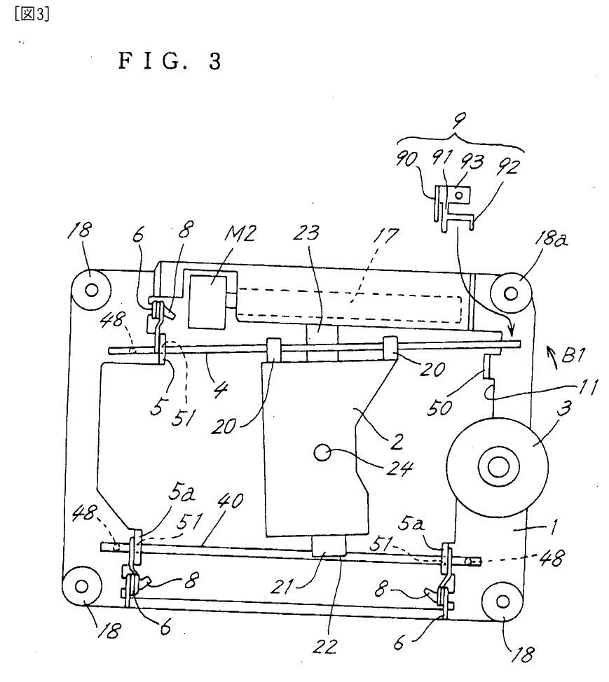

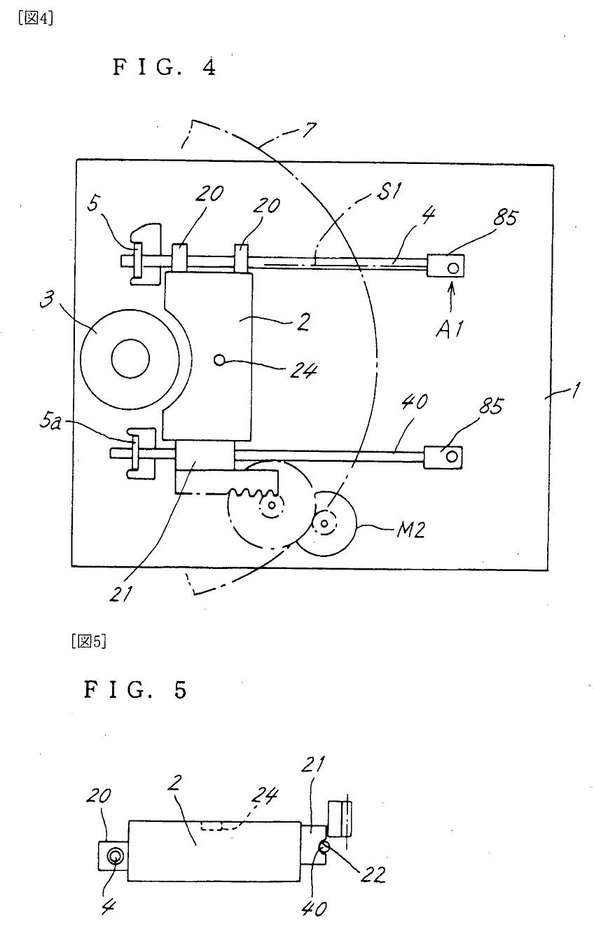

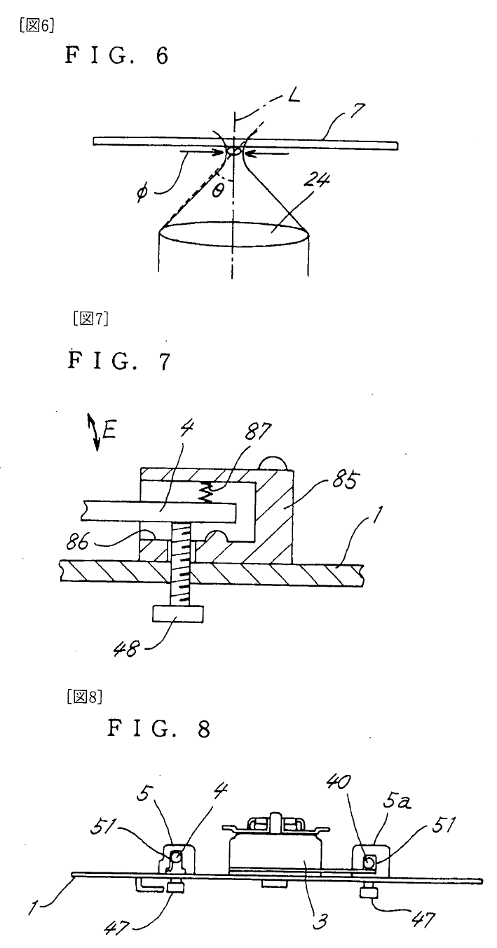

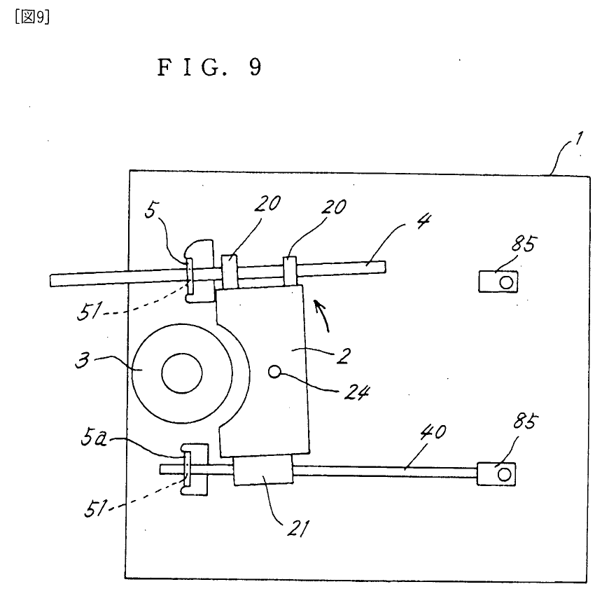

First, as shown in FIG. 3, the turn table (3), the screw shaft (17) and the pickup drive motor (M2) are fixed to the chassis (1), and further, the adjusting screws (48) are screwed from under the chassis (1). In this state, the guide shaft (40) serving as the auxiliary shaft is inserted into the vertical holes (51) and (51) sideways of the pair of first support members (5a) and (5a).

Next, the fitting piece (21) is fitted to the guide shaft (40) in a state in which an opening (22) formed at the fitting piece (21) in the pickup (2) is oriented toward the guide shaft (40) serving as the auxiliary shaft from the inside of the large opening (11).

Subsequently, as shown in FIG. 3, the pickup (2) is swung in a direction indicated by an arrow B1 within the plane parallel to the chassis (1). As described above, since the fitting piece (21) is fitted to the guide shaft (40) serving as the auxiliary shaft with a play, the pickup (2) can be readily swung.

The guide shaft (4) serving as the main shaft is inserted into the bearings (20) and (20) from the right of the pickup (2). During the swinging of the pickup (2), the right end of the guide shaft (4) is located outside of the second support member (50), to be thus prevented from abutting against the second support member (50).

Thereafter, the left end of the guide shaft (4) is inserted into the vertical hole (51) formed at the first support member (5). The first support member (5) is formed by bending the chassis (1), so that the thickness of the first support member (5) is equal to that of the chassis (1), and as a result, a bite between the first support member (5) and the guide shaft (4) is small. Consequently, the guide shaft (4) can be fitted to the first support member (5) even in the state in which the pickup (2) is swung.

Subsequently, the right end of the guide shaft (4) is inserted into the cutout (52) formed at the second support member (50) (see FIG. 2) from the outside of the second support member (50). Thereafter, the pickup (2) and the guide shaft (4) are swung in a direction reverse to the direction indicated by the arrow B1 in FIG. 3, so that both of the guide shafts (4) and (40) become parallel to each other. Since the bite between the first support member (5) and the guide shaft (4) is small, the pickup (2) and the guide shaft (4) can be swung. The right end of the guide shaft (4) is brought into contact with the side edge of the cutout (52) formed at the second support member (50).

The torsion springs (6) are fitted to the spring holding pieces (8), so that the respective ones of the leg pieces of the torsion springs (6) abut against the guide shafts (4) and (40). The guide shafts (4) and (40) are urged by the torsion springs (6), to be thus received by the adjusting screws (48).

Finally, as shown in FIG. 2, the pressing member (9) is fixed to the chassis (1) via the screw (55). As described above, the end surface (90a) of the abutting piece (90) abuts against the guide shaft (4), which can be thus restricted from slipping off outward. In addition, the guide shaft (4) can be restricted from being accidentally moved along the longitudinal direction to thus slip off from the support member (50) by the effect of the stopper piece (92). The guide shaft (4) is urged downward by the pressing piece (91) and the torsion spring (6), so that the inclinations of the guide shafts (4) and (40) can be adjusted by rotating the adjusting screws (48).

Although one pressing member (9) and one second support member (50) are provided in the above-described preferred embodiment, two pressing members (9) and two second support members (50) may be provided. Alternatively, the guide shaft (4) may be fitted to the pickup (2) in advance before the pickup (2) is swung in the direction indicated by the arrow B1.

(Advantageous Results of the Present Preferred Embodiment)

In the present preferred embodiment, the second support member (50) located in the vicinity of the pressing member (9) is sideways provided with the cutout (52), into which the guide shaft (4) can be inserted. Consequently, the guide shaft (4) can be sideways fitted to the second support member (50), thereby enhancing the workability in fixing the guide shaft (4) to the chassis (1) in comparison with the conventional art.

Additionally, the abutting piece (90) of the pressing member (9) can prevent the guide shaft (4) from slipping off from the cutout (52). The abutting piece (90) is formed by bending the mount plate (93), and its end surface (90a) presses the guide shaft (4). The abutting piece (90) is made of the plate member, and the flexure generated with the application of the force to the plate member is inversely proportional to the secondary moment at the cross section of the plate member. The secondary moment at the cross section in the case where the force is exerted at the end surface of the plate member is greater than that in the case where the force is exerted at the surface of the plate member, so that the plate member is hardly flexed. That is to say, even if a large swing force or a large impact is exerted on the guide shaft (4) within the plane parallel to the chassis (1), the abutting piece (90) is hardly flexed since the guide shaft (4) is pressed at the end surface (90a) of the abutting piece (90). Thus, it is possible to prevent any swing of the guide shaft (4).

1. A disk recording or reproducing apparatus including, on a chassis, a pickup, which is moved while emitting a laser beam onto a signal surface of a disk, and a pair of guide shafts for guiding the movement of the pickup, one guide shaft being fitted to the pickup with a fewer play than the other guide shaft, the disk recording or reproducing apparatus characterized in that:
both ends of the guide shaft fitted to the pickup with a fewer play are supported by support members mounted on the chassis, and further, a cutout, into which the guide shaft can be inserted, is formed on a side of at least one support member; and
a pressing member including an abutting piece is provided for preventing the guide shaft from slipping off from the cutout in the vicinity of the support member having the cutout formed thereat on the chassis.

2. A disk recording or reproducing apparatus according to claim 1, wherein the abutting piece in the pressing member is formed by bending a mount plate mounted on the chassis, the abutting piece abutting against the guide shaft at an end surface thereof.

3. A disk recording or reproducing apparatus according to claim 1, wherein the guide shaft is elevatably supported by the support member, and further, an adjusting mechanism is provided, on the chassis, for inclining the pickup and the guide shaft with respect to the signal surface of the disk.

4. A disk recording or reproducing apparatus according to claim 3, wherein the adjusting mechanism includes an adjusting screw screwed onto the chassis and a torsion spring provided, on the chassis, for urging the guide shaft toward the adjusting screw.

5. A method of fixing a pickup in a disk recording or reproducing apparatus including, on a chassis, a pickup, which is moved while emitting a laser beam onto a signal surface of a disk, and a pair of guide shafts for guiding the movement of the pickup, the guide shaft serving as a main shaft being fitted to the pickup with a fewer play than the guide shaft serving as an auxiliary shaft, wherein on the chassis are provided a support member, which has a cutout on a side thereof, and to which the guide shaft serving as the main shaft is fitted at the end thereof, and a pressing member for preventing the guide shaft from slipping off from the support member in contact with the end of the guide shaft, the method comprising the steps of:
fixing the guide shaft serving as the auxiliary shaft to the chassis;
fitting the pickup to the guide shaft serving as the auxiliary shaft;
swinging the pickup within a plane parallel to the chassis, to thus fit the guide shaft serving as the main shaft to the pickup;
fitting the guide shaft serving as the main shaft to the support member through the cutout formed on the side of the support member; and
fixing the pressing member to the chassis.
